(19) United States
(12) Patent Application Publication
(10) Pub. No.: US 2004/0168757 A1
(43) Pub. Date: Sep. 2, 2004

(54) Monolithic belts containing ethylene-alpha-olefin copolymers

(76) Inventors: Jurg Vogt, Luzern (CH); Willi Toggenburger, Reinach (CH)

Correspondence Address: David L Principe, Hodgson & Russ, Suite 2000, One M & T Plaza, Buffalo, NY, 14203-2391, US

(21) Appl. No.: 10/481,156

(22) PCT Filed: Jun. 11, 2002
(86) PCT No.: PCT/CH02/00310

(30) Foreign Application Priority Data
Jun. 21, 2001 (CH) 1134/01

(51) Int. Cl. F16G 1/14; F16G 5/12; C08F 210/16

(52) U.S. Cl. 156/137

(57) ABSTRACT

Monolithic belts (i.e. without woven fabric insert), in particular monolithic conveyer belts and drive belts, which consist of a thermoplastic material, containing a copolymer with a ratio of weight average molecular weight M_{w} to number average molecular weight Mₙ of 5.0:1 to 1.5:1, which show creep resistance while at the same time having significantly reduced material costs. The copolymer can in particular be produced by means of a metallocene “single-site” catalyst.

The present invention relates to monolithic belts, in particular monolithic conveyor belts and drive belts.

Belts can fulfil different functions at the same time: they must absorb mechanical forces in order to facilitate the transportation of goods or to drive a shaft or a wheel, and they must have a surface which satisfies specific demands (e.g. coefficient of friction, abrasion resistance, texture). Often the varied functions are performed by different layers of the belt. For example, a woven fabric ensures the transmission of force and a plastic coated layer ensures the required surface properties.

Examples of belts are conveyor belts and drive belts.

In a particular class of belts or conveyor belts all functions are provided for by only one material layer. One refers in this case to “monolithic” belts or conveyor belts. In order to be able to achieve the required properties, very high-quality and expensive thermoplastic elastomers are used. These must have in particular a low tendency to creep; a material with high creep rate would require the use of a woven fabric, in order to prevent the elongation of a belt or conveyor belt produced from that material, which is under constant tension load. Too much rigidity of the material would result in a tendency to cracking in the finished belt or conveyor belt.

Generally for monolithic belts or conveyor belts thermoplastic polyurethane elastomers (TPE-U) and thermoplastic polyester elastomers (TPE-E) are employed. Particular embodiments of such conveyor belts can also have fabrics laminated on the rear side, non-woven fabrics or reinforcements by unidirectional fibre bundles in the longitudinal direction of the belt.

The analogous fact exists for drive belts. Also in this case the force is frequently transmitted by a traction layer (a woven fabric or a highly rigid plastic band) and the surface properties are achieved by a friction layer (frequently rubber).

Drive belts with a round, trapeziform or polygon shaped cross-sectional area are all encompassed under the term profiled belts. In an analogous manner to the aforementioned example, for these classes of drive belts all functions are frequently provided for by a single material. It is then a “monolithic” profiled belt. Also in this case thermoplastic polyurethane-elastomers (TPE-U) or thermoplastic polyester-elastomers (TPE-E) can be utilised. Special embodiments with reinforcements by unidirectional fibre bundles exist.

The said thermoplastic elastomers TPE-E and TPE-U are relatively expensive plastics. Furthermore, they have the disadvantage that only quite special types are permissible for use for contact with foodstuffs. High joining temperatures (>180° C.) are necessary for the production of end to end connections. Moreover, TPE-U elastomers frequently have the disadvantage that they can be slightly hydrolysed at elevated temperature.

In WO-A-00/26268 interpolymers from ethylene/α-olefin/optional diene are disclosed, including also binary ethylene-α-olefin copolymers, such as, for example, ethylene-α-octene copolymer with a M_{w}/Mₙ ratio of at least 2.3. The suitability of these interpolymers for the production of a multitude of articles, among them being belts is mentioned. However, the suitability of these interpolymers for monolithic belts, is neither disclosed nor made obvious.

Catalysts for the polymerisation of olefins are disclosed in EP-A-0 922 711, among which also those with aluminoxane as co-catalysts. The catalysts are described as suitable for the production of, inter alia, ethylene/α-olefin copolymers with M_{w}/Mₙ from 2 to 4.6, preferably 2.6 to 4.2. It is mentioned that the polymers which are produced by means of these catalysts are suitable for the production of articles such as, for example, belts and tyre components, including tyre belts. However, the suitability of these copolymers for monolithic belts, is neither disclosed nor made obvious.

Polyolefin elastomers are described in WO-A-97/38019, including also ethylene-α-olefin-elastomers, as well as catalysts and co-catalysts for their production. These elastomers are supposedly useful for the production of a multitude of products, among which belts, so for example power transmission belts, V-belts, timing belts, conveyor belts and industrial flat belts.

In the abstract of JP-A-09/176402 a belt is disclosed that is produced from an ethylene-α-olefin copolymer rubber. The belt preferably contains two types of copolymer rubbers with different viscosity.

The object of the invention is the development of monolithic belts, in particular monolithic conveyor belts and profiled belts, which do not have the aforementioned disadvantages.

The object is achieved in accordance with the invention by the belt according to claim 1. The parameter ranges for M_{w}:Mₙ (see below) which are stated in claims 1 to 3 can in particular be brought about by the production of copolymers by means of “single-site” catalysts.

It was discovered that through the use of those copolymers from ethylene and α-olefins, monolithic belts, in particular monolithic conveyor belts and drive belts, can be produced which have comparable mechanical properties as those produced with use of TPE-U or TPE-E. This is surprising, since for monolithic belts the requirements as to the creep characteristics and the storage modulus E′ of the material are very high, and, the majority of the customary polyolefins, as is known, do not meet these requirements. For the ethylene-α-olefin copolymer employed according to the invention, the creep rate and the storage modulus E′ has up until now not been examined, according to the knowledge of the applicant, and they are also not observable without taking the appropriate specific measurements. Only the inventors of the present application have discovered that ethylene-α-olefin copolymers have both a low creep rate and a low storage modulus E′, which made it possible for them to produce from these materials monolithic belts, e.g. conveyor belts or monolithic drive belts. The ethylene-α-olefin copolymers to be utilised according to the invention are non-crosslinked and therefore are not elastomers or rubbers.

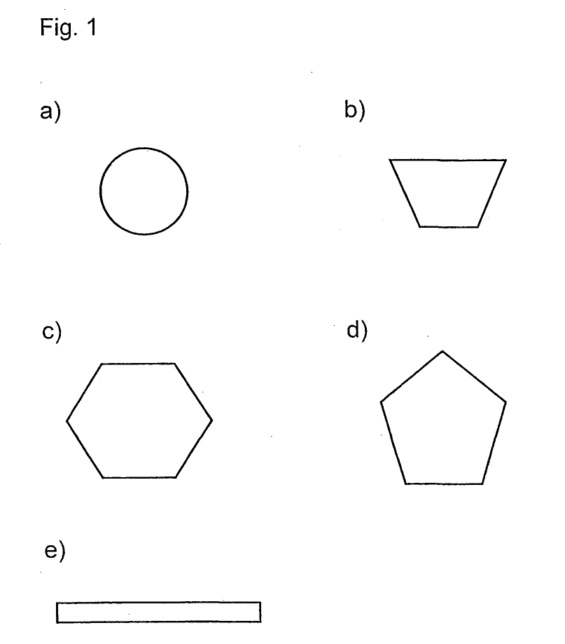

FIG. 1 shows different possible cross-sections of drive belts of this invention in the form of profiled belts, namely a) round belt, b) V-belt, c) double V-belt, d) ridge top belt and e) flat belt.

The term “monolithic” means in the context of the present application, that the belt does not contain a woven fabric. However in a preferred embodiment, a conveyor belt of this invention can nevertheless still have in addition on one side a woven fabric, non-woven fabric or scrim. “Monolithic”, in the context of the present application, can also mean that single reinforcement fibres are embedded in the belt in longitudinal direction. Consequently, in the centre of the monolithic drive belts of this invention, reinforcement fibres, for example from thermoplastic polyesters, polyamide 6, polyamide 66 or aromatic polyamides, may also be incorporated. In FIG. 1 showing cross sections through examples of drive belts of this invention in the form of profiled belts, the reinforcement fibres would be arranged approximately in the centre of the cross section and vertical to the plane of the page.

The term “belt” means in the context of the present application any belt which serves for the transmission of tractive force of a drive shaft, wheel or lever, or for the transportation of goods. Examples of belts are transmission belts, profiled belts (e.g. V-belts) and conveyor belts.

The term “α-olefin” has the meaning usual in the field of polyolefins, i.e. it indicates preferably unbranched hydrocarbons with a terminal C═C double bond. In the context of the present application the term “α-olefin” comprises those hydrocarbons with 3 to 12 carbon atoms, preferably 5 to 10 carbon atoms, particularly preferably 8 carbon atoms. Examples of such α-olefins are 1-propene, 1-butene, 1-pentene, 1-hexene and 1-octene; the most particularly preferred being 1-octene.

The terms “weight average molecular weight” M_{w} and “number average molecular weight” Mₙ have the meaning usual in the field of polyolefins, (compare for example Saechtling, “Kunststofftaschenbuch” 27^{th} edition, Carl Hanser Verlag Munich, page 17 f.):

$${M}_{w} = \frac{\sum {n}_{i} {M}_{i}}{\sum {n}_{i}} , {M}_{n} = \frac{\sum {n}_{i} {M}_{i}^{2}}{\sum {n}_{i} {M}_{i}}$$

M_{w} and Mₙ can be determined by customary processes according to the technology of polymer characterisation by, for example, chromatographic separation of a sample of the copolymer by means of gel permeation chromatography and at the same time the so obtained Fraction i can be analysed by means of scattered light photometry (Mᵢ, nᵢ). An example of such a complete set-up of measuring instruments with which these parameters can be determined, is the gel permeation chromatography system with Merck L6000 pump, separation column from Polymer Laboratories with 10⁶ Å exclusion limit, scattered light photometer DAWN DSP from Wyatt, light source He/Ne-laser of 632.8 nm.

Copolymers, which are employed in the belt of this invention, have a ratio as measured by a process as described above of M_{w}:Mₙ, that extends from about 5.0:1 to about 1.5:1. Preferably, for the copolymers in the belts of this invention this value is about 3.5:1 to about 1.5:1, particularly preferred being about 2.5:1 to about 1.5:1.

The copolymers utilisable according to this invention can typically have at 30° C. a creep rate Vₖ (measured in units from 1/log (min)) from about 0.002 to about 0.005, preferably from about 0.0025 to about 0.0035, particularly preferably from about 0.003, the definition and the measurement method of the creep rate Vₖ being as described in Example 1. At 40° C. this creep rate can typically be about 0.004 to about 0.008, preferably about 0.005 to about 0.007 and particularly preferably about 0.006; at 50° C. can it typically be about 0.005 to about 0.02, preferably about 0.0075 to about 0.015 and particularly preferably about 0.012.

The copolymers utilisable according to the invention can typically have at 30° C. a storage modulus E′ from about 50 MPa to about 200 MPa, preferably from about 75 MPa to about 125 MPa, particularly preferably from about 100 MPa, the definition and measurement method of the storage modulus E′ being as described in Example 2. At 40° C. this storage modulus can typically be about 40 MPa to about 120 MPa, preferably about 60 MPa to about 100 MPa and particularly preferably about 80 MPa; at 50° C. can it typically be about 30 MPa to about 100 MPa, preferably about 40 MPa to about 80 MPa and particularly preferably about 60 MPa.

The copolymers can be produced by “single-site” catalysts. The “single-site” catalyst is a catalyst which has been customarily used in the field of polyoelfins for about 10 years, which consists of a mixture of a metallocene of a metal of group IVa of the transition elements [e.g. bis(cyclopentadienyl)dimethylzirconium, but also metallocenes with only one cyclopentadienyl ligand and, if need be, further ligands] and a co-catalyst, in which the function of the co-catalyst is to convert the metallocene catalyst during the polymerisation reaction to the single positive charged state. The co-catalyst forms therefore a counter anion, that is not nucleophilic and is not co-ordinated on the metallocene. An example of the co-catalyst is e.g. polymeric methyl aluminoxane [MAO, -(Me-Al—O)ₙ—], that is used in such an amount that a Al:metallocene-molar ratio of about 100:1 to about 10 000:1 results. A further example of the co-catalyst are boranes with electronegative substituents, such as, for example, polyfluorinated aromatic hydrocarbons.

Examples for “single-site” catalysts are the monocyclopentadienyl metal catalysts which are described in U.S. Pat. No. 5,026,798, monocyclopentadienyl metal catalysts described in U.S. Pat. No. 5,132,380 and “constrained geometry” catalysts described in EP-A-0 416 815, disclosed in that case with the co-catalysts. These documents are included by reference.

Preferred examples of such catalysts are those “single-site” catalysts from Dow Chemicals which are known under the name INSITE® and those from Exxon Mobil Chemicals which are known under the name EXXPOL®. A particularly preferred example for a such catalyst is (tert-butylamido)dimethyl(tetramethyl-η⁵-cyclopentadienyl)silanetitaniumdimethyl+tris(pentafluorophenyl)borane in molar ratio Ti:B in this case of 1:1.

The production of the copolymers from ethylene and α-olefin by means of “single-site” catalysts is previously known in the field of polyolefins. For example, reference is made to the section 3.3.3 of the Chapter “Aluminium Compounds, Organic” in “Ullmann's Encyclopedia of Industrial Chemistry Sixth Edition 1999 Electronic Release” (English), as well as to the literature cited therein. Representative production examples of ethylene-α-olefin copolymers, as they are utilised in the belts of this invention, are the Examples 4, 5 and 11-77 of EP-A-0 416 815 and the Examples 1-4 of U.S. Pat. No. 5,272,236.

Examples of copolymers from ethylene and α-olefins which are customary in the market, which were synthesised by means of metallocene “single-site” catalysts and which are utilisable in the belts of this invention, are Affinity® and Engage® from Du Pont-Dow Elastomers or Exact® and Exceed® from DEX-Plastomers.

The belts of this invention consist of a thermoplastic material that comprises at least 70 percent by weight of ethylene-α-olefin copolymer. Preferably the thermoplastic material contains at least 90 percent by weight of the copolymer and particularly preferred the thermoplastic material consists of 100 percent by weight of the copolymer.

Further components of the thermoplastic material besides the copolymer can be other thermoplastic polymers such as TPE-O, for example EVA, EEA, EBA and EMA, and PP.

If desired, besides the copolymer and the optional further thermoplastic polymers, additives can be admixed with the thermoplastic material. This can include for example:

a) Processing aids such as lubricants, antiblock agents, separation agents, antistatic agents, propellants, nucleation agents;

b) Adjuvants for the improvement of the properties of the finished products such as for example UV- and temperature stabilisers, fireproofing agents, colorants, adhesion promoters, antibacterial or fungicidal additives; and

c) Fillers as dilutants for the reduction of plastics and thereby for the lowering of costs and/or for the improvement of the ability to process and the properties such as rigidity, impact resistance, heat stability, electric conductivity and dimensional stability and/or for the reduction of the thermal extension. In particular elongated or fibre-formed additive materials increase the strength.

The belts of this invention, conveyor belts or drive belts, can be produced with thermoplastic materials in an analogous manner to the previously known, thermoplastic material containing belts, conveyor belts or drive belts. Reference is made to Chapters 3.2.4, 3.2.5 and 3.2.6 from Saechtling, “Kunststofftaschenbuch” 27^{th} edition, Carl Hanser Verlag, Munich.

Textured surfaces can be generated by appropriate choice of material and performance of processes. Through deliberately generated melt fracture textured surfaces can also be generated for drive belts of this invention with the previously mentioned copolymers. The melt fracture is brought about by keeping the temperature of the nozzle relatively low, the mass throughput sufficiently high and by using a nozzle with a sharp-edged out-flow opening. The texture (roughness) of the belt surface of the drive belts of this invention is characterised by the maximum profile height R_{y} according to DIN 4762. The measurement of the profile of the surface occurs thereby expediently by cutting through a sample of the belt of this invention and photographing the profile cross-section through a microscope with a known enlargement factor. By measurements from the photograph and conversions by means of the enlargement factor, one can determine the standard required dimensions and parameters of the surface (centre line obtainable by least squares fit, distance of the highest point of the profile from the centre line, Rₚ, and distance of the lowest point from the centre line, Rₘ) mentioned above. Preferably belts of this invention have a maximal profile height R_{y} from 20 to 250 μm, particularly preferably from 70 to 140 μm.

The copolymers, which are used in the belts of this invention, in particular the aforementioned products available on the market, are in some cases authorised for use with contact with foodstuffs according to FDA 21 CFR 177.1520 “Olefin Polymers” para. c) 3.1 b. Conveyor belts of this invention with such copolymers can accordingly be utilised in the foodstuffs industry.

Since ethylene-α-olefin copolymers with the aforementioned favourable values for creep rate and storage modulus E′ are used, the monolithic belts of this invention, in particular conveyor belts and drive belts, are comparable to previously known analogous monolithic belts in respect of stability under tension load and flexibility, so that also with relatively small disc diameters cracking does not occur.

With the conveyor and drive belts of this invention end to end connections at temperatures around 120° C. can be carried out. Therefore standard presses can be used, which are also utilised in the production of end to end connections in light conveyor belts with multilayered construction. The resulting belts and bands are extremely resistant against hydrolysis.

The monolithic belts of this invention, in particular conveyor and drive belts, are differentiated from corresponding previously known belts and bands by their low material costs: the raw material costs are reduced by at least 50%.

Conveyor and drive belts of this invention have the advantage over conveyor and drive belts with copolymers with Mw:Mn greater than 5.0:1 that they have lower extractable fractions, so that they achieve a higher heat stability.

The invention is now further illustrated through the following examples. These serve only for illustration, but not to restrict the scope of protection.

### EXAMPLE 1

The creep rate Vₖ of a ethylene-α-olefin copolymer utilisable according to his invention (Exact 0203, DEX Plastomers, 6401 Heerlen, NL) and, for comparison, of a low density polyethylene (polyethylene 410R, Dow Plastics, CH-8810, Horgen, Switzerland), as well as of a thermoplastic polyolefin elastomer (Milastomer 9020 N, Mitsui Petrochemical Industries, Tokyo, Japan) was measured. In each case a test sample of 6.0×2.0×255 mm was measured. Each of the three materials was measured at 30° C., 40° C. and 50° C., a new test sample being used each time.

To perform a measurement the sample was inserted in the sample holder for the tension test of the measurement equipment (TA Instruments Dynamic Mechanical Analyser 2980). The sample was thermostatted in a closed measuring chamber of the measurement equipment at the chosen test temperature for 10 minutes. The temperature during the thermostatting and the actual measurement was maintained with an accuracy of ±0.1° C. After the thermostatting the sample was subjected to the maximum possible speed of the measuring equipment to a tensile stress 1.20 MPa. This tensile stress was constantly maintained for 100 minutes. Throughout the total test duration the length of the sample was recorded with an accuracy of 10⁻⁵ mm. After that was the sample abruptly relieved (tensile stress 0.01 MPa) and the temperature was constantly maintained for a further 10 minutes.

For the analysis the length of the sample was plotted against the common logarithm of the time. In the nearly linear range of the resulting curve the creep rate vₖ:

Vₖ=(ε₁−ε₀)/(log t₁−log t₀), [vₖ]=1/log(min)

was defined as the slope of the curve. In the above formula t₀ means the time to the beginning of the nearly linear range of the curve, t₁ is 100 min, ε₀ is the extension of the sample at time point t₀ and ε₁ is the extension of the sample at time point t₁.

The following measurements for vₖ (in 1/log(min)) were obtained:

| Temp. (° C.) | Exact 0203 | PE 410R | Milastomer 9020N |
|---|---|---|---|
| 30 | 0.00293 | 0.00512 | 0.04106 |
| 40 | 0.00619 | 0.00676 | 0.06396 |
| 50 | 0.01181 | 0.00649 | 0.08816 |

The creep rate of the ethylene-α-olefin copolymer Exact 0203 is up to 20 times lower as that of the Elastomer 9020N and lies in the same range as the creep rate of the polyethylene PE 410R, the latter, however, being much too rigid for the production of a monolithic belt.

### EXAMPLE 2

The storage modulus E′ of the same polymers as in Example 1 was measured. This storage modulus is related to the complex elasticity modulus E* as follows:

E*=E′+i·E″,

in which E″ is the loss modulus. E′ and E″ are therefore real and imaginary parts respectively of the elasticity modulus E*.

For the measurement of E′, in each case a test sample with the same dimensions as in Example 1 was used. For this the sample was inserted in the sample holder for the tension test of the measurement equipment (TA Instruments Dynamic Mechanical Analyser 2980). The test sample was first cooled down from room temperature to −50° C. at a rate of 3° C./min and kept constantly for 10 minutes at this temperature. Afterwards the sample was warmed up at a rate of 2° C./min to +80° C. Throughout the total duration the sample was subject to a cyclical, sinus shaped elongation with an amplitude of 5 μm and a frequency of 10 Hz in which the storage modulus E′ was constantly measured.

For three exemplary temperatures (30° C., 40° C., and 50° C.) from the warming up period, the following values for the storage modulus E′ (in MPa) were obtained:

| | | | Milastomer |
|---|---|---|---|
| Temp. (° C.) | Exact 0203 | PE 410R | 9020N |
| 30 | 105 | 475 | 102 |
| 40 | 85 | 364 | 84 |
| 50 | 56 | 261 | 67 |

The ethylene-α-olefin copolymer Exact 0203 has a 4 to 5 times lower storage modulus E′ in comparison to the polyethylene PE 410R. The storage modulus of the elastomer 9020N is comparable with that of the copolymer, however that elastomer has a substantially lower creep resistance than the ethylene-α-olefin copolymer (see Example 1).

### EXAMPLE 3

With a single screw extruder (manufacturer Maillefer), which was equipped with a barrier screw and with a round nozzle with an inner diameter of 7.0 mm, a round belt of a copolymer of ethylene and 1-octene, which had been synthesised with the aid of metallocene catalysts and which had a density of 0.902 g/m3 (Typ Exact® 0203, Manufacturer DEX-plastomers) was produced according to the state of the art. The mass temperature in the extruder was 190° C. By cooling of the nozzle to 178° C. and by the use of a very sharp-edged hole type nozzle a deliberate melt fracture was produced. Therefore a rough surface with a maximal profile height R_{y} according to DIN 4762 of about 140 μm resulted.

The belt had a diameter of 7.0 mm and had the following properties:

| Force at 1% elongation: | 26.4 N |
|---|---|
| Tension at elongation of 1% | 0.68 MPa |
| Elongation after 48 h tensile stress of 1.12 MPa | 2.6% |
| Permanent elongation after 48 h at 1.12 MPa | 0.2% |

Both the elongation after 48 hours under tractive loads and the permanent elongation are smaller or the same as for a comparable round belt from TPE-U.

### EXAMPLE 4

With a conventional single screw extruder (manufacturer Maillefer), equipped with a barrier screw and a slit nozzle, a monolithic conveyer belt was produced according to the state of the art from a copolymer of ethylene and 1-octene, which was synthesised with help of metallocene catalysts and had a density of 0.902 g/m3 (Typ Exact® 0203, manufacturer DEX-Plastomers). The belt had a thickness of 2.0 mm. It had the following properties:

| Force at 1% elongation | 1.63 N/mm |
|---|---|
| Force at 1% elongation relaxed (EN 1723) | 1.20 N/mm |
| Permanent elongation (EN 1723) | 0.20% |

The ends of the belt could be connected at 120° C. with conventional techniques. According to FDA 21 CFR 177.1520, “Olefin Polymers” para. c) 3.1b it is authorised for use in contact with all types of foodstuffs up to a temperature of 65° C. The belt is resistant against hot water up to 90° C.

1. Monolithic belt, characterised in that it consists of a thermoplastic material, comprising at least 70 percent by weight of a copolymer of ethylene and a α-olefin, and that the copolymer has a ratio of weight average molecular weight M_{w} to number average molecular weight Mₙ of 5.0:1 to 1.5:1.

2. Belt according to claim 1, characterised in that the copolymer has a ratio M_{w}:Mₙ of 3.5:1 to 1.5:1.

3. Belt according to claim 2, characterised in that the copolymer has a ratio M_{w}:Mₙ of 2.5:1 to 1.5:1.

4. Belt according to any one of claims 1 to 3, characterised in that the copolymer is produced by means of a “single-site” catalyst.

5. Belt according to claim 4, characterised in that the “single-site” catalyst is (tert-butylamido)dimethyl(tetramethyl-η⁵-cyclopentadienyl)silanetitaniumdimethyl+tris(pentafluorophenyl)borane in molar ratio Ti:B of 1:1.

6. Belt according to any one of claims 1 to 5, characterised in that the thermoplastic material comprises at least 90 percent by weight of copolymer.

7. Belt according to claim 6, characterised in that the thermoplastic material consists of 100 percent by weight of copolymer.

8. Belt according to any one of claims 1 to 7, characterised in that the α-olefin has 5 to 10 carbon atoms.

9. Belt according to claim 8, characterised in that the α-olefin is 1-octene.

10. Belt according to any one of claims 1 to 9, characterised in that it consists of a thermoplastic material, comprising a copolymer that is authorised for use in contact with foodstuffs.

11. Belt according to any one of claims 1 to 10, characterised in that it is in the form of a drive belt or conveyer belt.

12. Conveyer belt according to claim 11, characterised in that is covered on one side with a woven fabric or non-woven fabric.

13. Drive belt according to claim 11, characterised in that it is a profiled belt with a form of a round belt, V-belt, double V-belt, ridge top belt, or flat belt.

14. Drive belt according to claim 11 or 13, characterised in that it is fibre reinforced.

15. Drive belt according to any one of claims 11, 13 or 14, characterised in that it has a surface with a maximum profile height R_{y} according to DIN 4762 of 20 to 250 μm.

16. Use of a copolymer of ethylene and a α-olefin with a ratio of weight average molecular weight M_{w} to number average molecular weight Mₙ of 5.0:1 to 1.5:1, for the production of a monolithic belt.

17. Use according to claim 16, characterised in that the copolymer is produced by means of a “single-site” catalyst.
